(19) United States
(12) Patent Application Publication
(10) Pub. No.: US 2021/0235962 A1
(43) Pub. Date: Aug. 5, 2021

(54) CLEANING TANK

(71) Applicant: INTERACTIVE SERVICES (VIC) PTY LTD, Arundel (AU)

(72) Inventor: Damian MCINERNEY, Arundel (AU)

(21) Appl. No.: 17/049,699

(22) PCT Filed: Apr. 25, 2019
(86) PCT No.: PCT/AU2019/050368

§ 371 Date: Oct. 22, 2020

(30) Foreign Application Priority Data
Apr. 26, 2018 (AU) 2018901376

(51) Int. Cl. A47L 15/28; A47L 15/00; A47L 15/42; A47L 15/46; A47L 15/50

(52) U.S. Cl. CPC A47L 15/28; A47L 2501/36; A47L 15/0092; A47L 15/4285; A47L 15/46; A47L 15/4274; A47L 15/4209; A47L 15/506; A47L 15/4287; A47L 15/4263; A47L 2401/12; A47L 2501/32; A47L 2501/06; A47L 2501/26; A47L 15/0076

(57) ABSTRACT

This invention relates in general to an industrial cleaning apparatus. The cleaning apparatus has a cleaning tank which has a generally rectangular configuration having two opposing major sides, two opposing minor sides and an opening. A lid is pivotally connected to one of the major sides and adapted to allow access to the cleaning tank when opened and to close the opening of the cleaning tank in use. A horizontally disposed support frame supports the kitchen articles within the cleaning tank. A heating system is disposed within the cleaning tank and heats the fluid therein. A lift assembly raises and lowers the support frame by a remotely operated control system. In use, when the lift assembly is remotely controlled to raise and lower the support frame a corresponding vertical motion of the support frame opens and closes the lid.

### CROSS REFERENCE TO RELATED APPLICATIONS

This application is a filing under 35 U.S.C. 371 of International Application No. PCT/AU2019/050368, filed Apr. 25, 2019, entitled “CLEANING TANK,” which claims priority to Australian Patent Application No. 2018901376, filed Apr. 26, 2018, which applications are incorporated by reference herein in their entirety.

### FIELD OF THE INVENTION

The invention relates in general to a tank used for cleaning purposes. In particular, the invention provides an industrial cleaning tank with an automatic lift assembly whereby a user can remotely open and close the tank at the same time as raising and lowering a basket therein. The present invention has been found to be particularly useful for cleaning kitchen articles, for example industrial, commercial or catering kitchen articles.

### BACKGROUND OF THE INVENTION

It should be noted that reference to the prior art herein is not to be taken as an acknowledgement that such prior art constitutes common general knowledge in the art.

When cooking or preparing food, often kitchen articles such as pots and pans, baking trays, and kitchen utensils become contaminated with baked or burnt on foodstuffs and often require special cleaning methods. For hygiene and efficiency reasons, these dirty articles are cleaned by immersing them in a cleansing fluid at elevated temperature. The cleansing fluid is typically selected as being the most effective at removing a particular type of contamination. For example, for cleaning kitchen articles with baked on grease a detergent which is a non-caustic alkaline formulation may be utilised. Some cleansing fluids used are often hazardous in nature, being corrosive or toxic. Even a non-hazardous fluid such as water presents a hazard at elevated temperatures.

Industrial cleaning tanks are used for cleaning items such as cookware and food preparation equipment by providing a high temperature cleaning bath in which the cleaning items are immersed for period of time. For convenient handling by an operator, the tanks provide a basket for holding the objects to be cleaned. The operator is required to fill the basket with items to be cleaned before manually lowering the basket into the tank. When the cleaning process is complete the operator must then lift the basket from the tank. Due to the weight of the items in the basket the process of filling and emptying the tank can cause strain on the operator and can easily lead to injury. Tanks containing hot liquids also pose the risk of scalds or burns to the operator.

Improvements in industrial cleaning tanks have seen the introduction of automatic lifting mechanisms. These automatic lifting mechanisms are particularly beneficial as the equipment being cleaned is often very heavy, with loads of 90 kg or more needing to be raised and lowered from within the cleaning tanks. However the development in technology has brought an increase in the complexity in the design of these industrial cleaning tanks. For example, the drive components must be located outside of the wet and hot environment located inside the tank. Therefore, some form of arm must connect the drive components to the basket within the tank to raise and lower the basket. While these automatic lifting mechanisms have been designed to raise and lower the basket within the tank an operator is still required to open and close the lid or tank closure device before raising the basket from within the tank. This does not remove the risk of the operator from coming into contact with the hazardous cleaning fluids and the risk of possible scalds or burns from the hot liquids.

Due to the heavy loads which are sometimes required to be raised and lowered from the cleaning tanks there can be a problem with balancing the load within the basket to prevent binding of the basket within the interior of the tank. This becomes problematic for any automatic lifting mechanism, the binding of the basket can place an excessive load on the lifting mechanism and prevent the operation of the cleaning tank.

Also with the complexity and added components brings further difficulties when it comes to maintenance of the machines. More moving parts means an increase in the maintenance of components and can also mean an increase in the cost of maintenance. The increased number of parts can also make it more difficult to clean the machines. As such, it is important that any cleaning apparatus be easy, effective and safe to use, as well as being easy to maintain.

Clearly it would be advantageous if a tank used for cleaning purposes could be devised that helped to at least ameliorate some of the shortcomings described above. In particular, it would be beneficial to provide an industrial cleaning tank with an automatic lift assembly whereby a user can remotely open and close the tank at the same time as raising and lowering a basket therein or at least provide the public with a useful choice.

### SUMMARY OF THE INVENTION

The present invention has been developed to provide a heated cleaning tank or soak tank with a lift assembly for raising and lowering the support frame and lid simultaneously. An operator located a safe distance from the soak tank uses a remote control to raise and lower the support structure or basket which at the same time opens and closes the lid. The heated cleaning tank or soak tank is designed to remove fats, oils, grease and carbon buildup from kitchen articles.

In accordance with a first aspect, the present invention provides a cleaning apparatus comprising: a cleaning tank adapted to contain a fluid for immersing kitchen articles, the cleaning tank having a generally rectangular configuration with an opening, the cleaning tank having an external cabinet spaced apart from an internal tank with an upper edge formed therebetween, the external cabinet and internal tank having two opposing major sides, two opposing minor sides and a recessed channel formed in the upper edge and extending around the major and minor sides of the external cabinet and internal tank; a lid pivotally connected to one of the major sides of the cleaning tank, the lid adapted to allow access to the cleaning tank when opened and to close the opening of the cleaning tank in use, the lid having a raised rim which when the lid is in the closed position is received within the recessed channel in the upper edge between the external cabinet and the internal tank to seal the opening of the cleaning tank; a horizontally disposed support frame for supporting the kitchen articles within the cleaning tank, the support frame has a generally rectangular configuration with a pair of major side walls, a pair of minor side walls and a base; a vertical support member extends upwardly from a position centrally located on the base and adjacent one of the major side walls of the support frame; a heating system disposed within the cleaning tank and adapted to heat the fluid therein; a lift assembly located between the external cabinet and a rear wall of the internal tank, the lift assembly is adapted to raise and lower the support frame; a remotely operated control system with a remote control for operating the lift assembly, the remote control allowing the an operator located a safe distance from the cleaning apparatus to raise and lower the support frame; and wherein as the support frame is raised and lowered, the vertical support member engages with an internal surface of the lid, such that when the lifting means moves the support frame from the lowered position to the raised position the vertical support member raises the lid.

Preferably, the space between the external cabinet and the internal tank may contain an insulating material designed to restrict the propagation of heat from the internal tank to the external cabinet.

Preferably, the lift assembly may comprise a lifting means connected to the support frame to move the support frame from a lowered position in which the kitchen articles are immersed in the fluid and the lid is in the closed position, and a raised position wherein the support frame is in close proximity to the opening of the cleaning tank such that it is easily accessed and the lid is in the open position.

Preferably, the apparatus may further comprise one or more lifting guides being provided within the internal tank and/or support frame, and configured to assist with linearly raising and lowering of the support frame. The lifting guides may comprise one or more rails or channels together with complementary guide elements. A pair of rails or channels may be provided on each opposing minor side wall of the internal tank, each rail or channel extending vertically down from a position adjacent the opening of the cleaning tank. The guide elements may be a T-shaped element provided on the support frame.

Preferably, the support frame may be shaped to fit within the internal tank. The T-shaped guide elements may be provided on an external side of one or more of the minor side walls of the support frame, each T-shaped guide element is positioned to correspond with one of the pair of rails or channels on the opposing minor side walls of the internal tank to allow the support frame to be guided for movement within the internal tank.

Preferably, the support frame base may have a bottom portion which comprises a plurality of draining apertures.

Preferably, the support frame may further comprise a lid engaging member extending perpendicular to and depending from an end of the vertical support member.

Alternatively, the support frame may further comprise two vertical support members spaced apart an equal distance either side of a centerline running through the middle of the cleaning tank and extending from the base and adjacent one of the major side walls of the support frame and a lid engaging member extending perpendicular to and depending from an end of each vertical support member.

Preferably, the lid engaging member may comprise at least one rolling element adapted to engage an internal surface of the lid, such that when the lifting means moves the support frame from the lowered position to the raised position the rolling element engages with the internal surface of the lid to simultaneously raise the lid.

Preferably, the lifting means may further comprise an actuating assembly connected to the lid engaging member.

Preferably, when the cleaning apparatus comprises two vertical support members the actuating assemblies connected to each vertical support member may be synchronized such that they travel the same distance at the same time.

Preferably, the actuating assembly may comprise an electric linear actuator and a telescopic element whereupon action of the electric linear actuator causes the telescopic element to extend or retract according to the movement of the actuator. The electric linear actuator and the telescopic element may be positioned to be located between the external cabinet and the rear wall of the internal tank. The telescopic element may extend through an aperture located in a top section of the rear wall of the internal tank.

Preferably, the cleaning tank may further comprise a fluid outlet from the cleaning tank, the fluid outlet being provided at a bottom region of the internal tank. The fluid outlet may further comprise a valve being in fluid communication with the fluid outlet, the valve being provided at the bottom region and adjacent one of the opposing minor sides of the cleaning tank.

The lid may be pivotally connected by a hinge to one of the major sides of the cleaning tank.

Preferably, the lid may further comprise a drip rail attached adjacent a side of the inner surface of the lid, when the lid is the open position, the drip rail is adapted to provide a channel back into the internal tank of the cleaning apparatus for fluid accumulated on the inner surface of the lid during use.

Preferably, the heating system may comprise a heating element, at least one thermostat to control the temperature of the heated fluid, a temperature sensor and an indicator to show the temperature of the fluid in the cleaning apparatus.

Alternatively, the heating system may comprise two thermostats, a first thermostat to prevent the heating fluid from exceeding a pre-determined temperature and a second thermostat as a redundant backup should the first thermostat fail. The heating system may further comprise a lockout system which is activated by the second thermostat to indicate that the temperature of the fluid within the internal tank has exceeded the pre-determined temperature and the first thermostat has failed to operate. The lockout system may further comprise at least one indicator located on the external cabinet to provide a visual warning that the second thermostat has been activated. The lockout system may be adapted to shut-down operation of the cleaning apparatus and requires a technician to reset the cleaning apparatus prior to re-use.

In accordance with a further aspect, the present invention provides a method for cleaning kitchen articles comprising the steps of: a) providing a cleaning tank having an external cabinet spaced apart from an internal tank for containing a fluid for immersing kitchen articles, the cleaning tank comprising a horizontally disposed support frame for supporting the kitchen articles within the cleaning tank, the support frame has a generally rectangular configuration with a pair of major side walls, a pair of minor side walls and a base, a vertical support member extends upwardly from a position centrally located on the base and adjacent one of the major side walls of the support frame, a lift assembly located between the external cabinet and a rear wall of the internal tank, the lift assembly is adapted to raise and lower the support frame, a remotely operated control system with a remote control for operating the lift assembly, the remote control allowing an operator located a safe distance from the cleaning tank to raise and lower the support frame, a heating system for heating the fluid in the cleaning tank and a lid for closing an opening of the cleaning tank; b) filling the cleaning tank with the fluid for cleaning the kitchen articles; c) operating the remote control at the safe distance from the cleaning tank to raise the lift assembly and allowing the vertical support member to engage with an internal surface of the lid to open the lid and position the support frame adjacent the opening of the cleaning tank; d) loading the support frame with kitchen articles to be cleaned; e) operating the remote control at the safe distance from the cleaning tank to lower the lift assembly which positions the support frame within the cleaning tank such that the kitchen articles are immersed in the fluid and at the same time the vertical support member disengages with the internal surface of the lid to allow the lid to be lowered to cover and seal the opening in the cleaning tank; f) heating the fluid within the cleaning tank and soaking the kitchen articles in the heated fluid for a pre-determined period of time; and g) operating the remote control at the safe distance from the cleaning tank to raise the lift assembly and allowing the vertical support member to engage with the internal surface of the lid to open the lid, when the support frame is positioned adjacent the opening of the cleaning tank the operator can remove the cleaned kitchen articles from the cleaning tank.

Preferably, the method may further comprise any of the features of the cleaning apparatus of the first aspect.

Preferably, step b) may further comprise filling the cleaning tank with water and adding a chemical concentrate to dissolve in the water to form a solution. The chemical concentrate may be a detergent, the detergent is a non-caustic alkaline formulation which is biodegradable, non-toxic and non-corrosive.

Preferably, after step g) the kitchen articles removed from the cleaning tank may be washed in clean water to remove any residual cleaning fluid prior to re-use.

In accordance with a still further aspect, the present invention provides a cleaning apparatus comprising: a cleaning tank containing a fluid for immersing kitchen articles, the cleaning tank having an external cabinet spaced apart from an internal tank, the external cabinet comprising a generally rectangular configuration having two opposing major sides, two opposing minor sides and an opening with a recessed channel extending around the major and minor sides of the opening, the internal tank comprising a rear wall, a front wall and opposing side walls, and an insulating material inserted in the space between the external cabinet and the internal tank; a lid pivotally connected to one of the major sides of the cleaning tank, the lid adapted to allow access to the cleaning tank when opened and to close the opening of the cleaning tank in use, the lid has a rim which when the lid is in the closed position is received within the channel in the opening of the cleaning tank to form a seal with the opening; a horizontally disposed support frame for supporting the kitchen articles within the cleaning tank; a heating system disposed within the cleaning tank and adapted to heat the fluid therein; a lift assembly for raising and lowering the support frame; and a remotely operated control system with a remote control for operating the lift assembly, the remote control allows an operator to raise and lower the support frame and a corresponding vertical motion of the support frame simultaneously opens and closes the lid while allowing the operator to maintain a safe distance from the cleaning apparatus to avoid contact with the heated fluid at elevated temperatures.

Preferably, the cleaning apparatus may further comprise any of the features of the cleaning apparatus of the first aspect.

Any one or more of the above embodiments or preferred features can be combined with any one or more of the above aspects.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

FIG. 1 shows a perspective view of the cleaning apparatus in accordance with an embodiment of the present invention;

FIG. 2 shows a front plan view of the cleaning apparatus of FIG. 1;

FIG. 3 shows a rear plan view of the cleaning apparatus of FIG. 1;

FIG. 4 shows one end plan view of the cleaning apparatus of FIG. 1;

FIG. 5 shows another end plan view of the cleaning apparatus of FIG. 1;

FIG. 6 shows a top plan view of the cleaning apparatus of FIG. 1;

FIGS. 7 and 7A illustrate a perspective sectional view and exploded sectional segment of the cleaning apparatus of FIG. 1;

FIG. 8 shows a top section view of the cleaning apparatus of FIG. 1 with the lid in the open position;

FIGS. 9 and 10 show a top view of the internal tank and heating element of the cleaning apparatus of FIG. 1;

FIG. 11 shows a perspective view of the basket removed from the cleaning apparatus of FIG. 1;

FIG. 12 illustrates a perspective view of the basket and internal tank of the cleaning apparatus of FIG. 1 when viewed from above;

FIG. 13 shows an end detailed view of one end of the basket in the raised position of the cleaning apparatus of FIG. 1;

FIG. 14 illustrates a rear perspective view of the cleaning apparatus of FIG. 1 showing some of the electrical components and the lifting means;

FIGS. 15 to 17 show perspective views of three stages of operation of the cleaning apparatus of FIG. 1;

FIG. 18 shows a perspective view of the cleaning apparatus in accordance with a second embodiment of the present invention;

FIG. 19 illustrates a perspective view of the basket and internal tank of the cleaning apparatus of FIG. 18 when viewed from above;

FIG. 20 illustrates a rear perspective view of the cleaning apparatus of FIG. 18 showing some of the electrical components and the two lifting means;

FIG. 21 illustrates a simplified schematic wiring diagram of the cleaning apparatus of FIG. 1; and

FIG. 22 illustrates a simplified schematic wiring diagram of the cleaning apparatus of FIG. 18.

### DETAILED DESCRIPTION OF THE INVENTION

The following description, given by way of example only, is described in order to provide a more precise understanding of the subject matter of a preferred embodiment or embodiments.

It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature or component extending in or along a given direction or the like does not mean that the feature or component follows a straight line or axis in such a direction or that it only extends in such direction or on such a plane without other directional components or deviations, unless otherwise specified.

Reference will now be made to the drawings in which the various elements of embodiments will be given numerical designations and in which embodiments will be discussed so as to enable one skilled in the art to make and use the invention. It will be further noted that the figures are schematic and provided for guidance to the skilled reader and are not necessarily drawn to scale. Rather, the various drawing scales, aspect ratios, and numbers of components shown in the figures may be purposely distorted to make certain features or relationships easier to understand.

The present invention in a broadest form provides a heated cleaning tank or soak tank 10, 200 with a lift assembly 110 for raising and lowering the support frame 40 and lid 60 simultaneously. An operator 11 located a safe distance from the soak tank 10, 200 uses a remote control 70 attached to cable 71 to raise and lower the support structure or basket 40 which at the same time opens and closes the lid 60. The heated cleaning tank or soak tank 10, 200 is designed to remove fats, oils, grease and carbon buildup from kitchen articles. By way of example only, some of the kitchen articles which can be cleaned include pots, pans, baking trays, oven racks, grills, and kitchen utensils. Typically these articles are found in industrial, commercial or catering kitchens. The soak tanks 10, 200 are designed to clean all types of metal including aluminum. Also, the present invention is not only limited to cleaning kitchen articles and may be utilised for cleaning other similar articles which can have a similar carbon buildup which requires cleaning in a heated soak tank 10, 200.

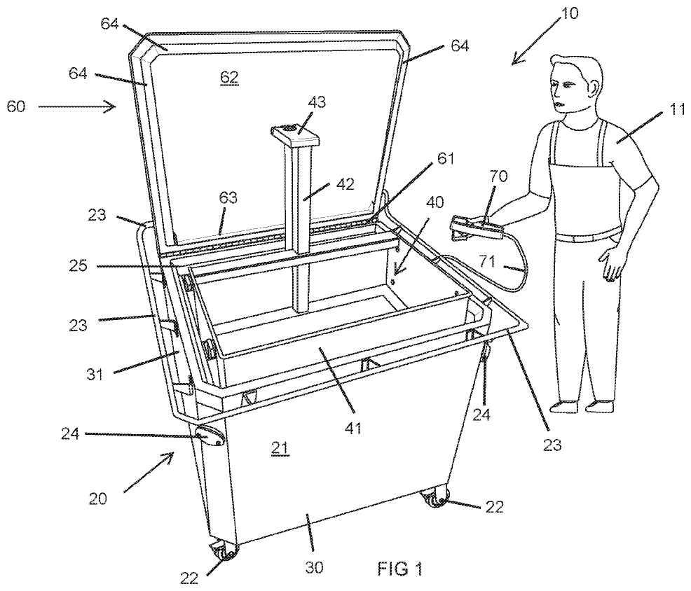

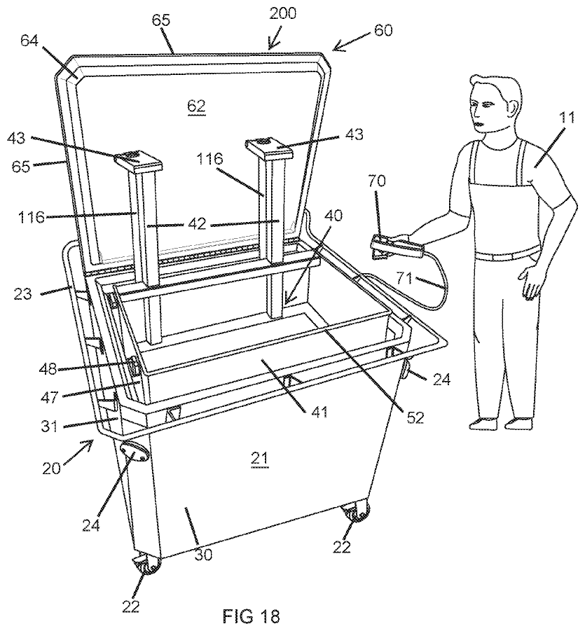

FIGS. 1 to 17 show a first embodiment of the heated cleaning tank 10 for cleaning kitchen articles. FIGS. 18 to 20 show a second embodiment of the heated cleaning tank 200 for cleaning kitchen articles. Specific reference to components, process steps, and other elements are not intended to be limiting. Further, it is understood that like parts bear the same reference numerals, when referring to alternate figures and different embodiments.

FIG. 1 illustrates a cleaning apparatus 10 with a cleaning tank 20. The cleaning tank 20 is formed by the external cabinet 21, an internal tank 28 separated by an insulating material 27. The internal cabinet 28 is designed to retain a cleaning fluid 29 within the internal tank 28. The cleaning fluid 29 is a chemical concentrate dissolved in water to form the cleaning fluid. Typically the chemical concentrate is a detergent which is a non-caustic alkaline formulation which is biodegradable, non-toxic and non-corrosive. The detergent may be in liquid or powder form and is a surfactant or a mixture of surfactants with cleaning properties in dilute solutions.

The insulating material 27 which fills the space between the internal tank 28 and the external cabinet 21 is any form of insulation which prevents or at least restricts the propagation of heat from the internal tank 28 to the external cabinet 21. The insulating material 27 is a polyurethane spray foam or the like, which is used to fill the space between the internal tank 28 and the external cabinet 21. The insulating foam 27 is highly adhesive and sets almost instantly making it highly durable and does not deteriorate over time. The insulating material 27 has a high R-value or thermal resistance to heat flow and functions to provide an insulation envelope around the internal tank 28. The envelope ensures that the heat generated by heating the fluid 29 within the internal tank 28 is kept inside. This insulating material 27 forms a barrier to both conductive and convective heat transfer. The insulation material 27 also provides some form of structural integrity to walls of the heating apparatus 10, 200 while keeping the external cabinet 21 always cool to touch. By providing an insulating material 27 which provides a high thermal resistance aids in reducing the operating costs of the cleaning apparatus 10, 200. The insulating material 27 prevents energy loss and provides a more energy efficient soak tank 10, 200.

Both the external cabinet 21 and the internal tank 28 are constructed from a food-grade stainless steel. For example, the stainless steel may be a 304 or 316 grade stainless steel which can be used for sanitary food handling applications. This provides the external cabinet 21 and the internal tank 28 with a material which can stand-up to high temperatures and provides a material with a protective oxide layer which helps prevent the formation of rust that could contaminate foodstuffs.

The cleaning tank 20 may be considered to have a generally rectangular configuration. In other words, the external cabinet 21 as shown in FIGS. 1 to 7 can be considered to have two opposing longer or major, sides 30, 35 and two opposing shorter or minor, sides 31, 32. The internal tank 28 also has a generally rectangular shape with two opposing longer or major, sides 30a, 35a and two opposing shorter or minor, sides 31a, 32a. The external cabinet 21 also has a base or bottom 33 with a u or v-shaped channel 97 extending substantially along the length of the base 33 and positioned either side of the centerline running through the cleaning tank 20. The internal tank 28 has a corresponding base 33a with the u or v-shaped channel 97a, the channel 97a is shaped to house the heating element 130. The cleaning tank 20 is designed to have a particular depth or height to allow immersion of the kitchen articles therein.

Located on each corner of the base 33 are castor wheels 22 which allow the soak tank 10 to be easily moved around a kitchen. At least two, and preferably the two castor wheels 22 located adjacent the front major side 30 of the soak tank 10 are able to be locked to prevent movement of the soak tank 10. A handrail 23 extends around the periphery of the top of the cleaning tank 20. The handrail 23 being spaced apart from each side of the external cabinet 21 by mounting arms 26. The part of the handrail 23 which extends along the rear side 35 is inclined upwards at either end to raise the height of the handrail 23 to a position in which the handrail 23 act as a stop for the lid 60 when the lid 60 is in the open position.

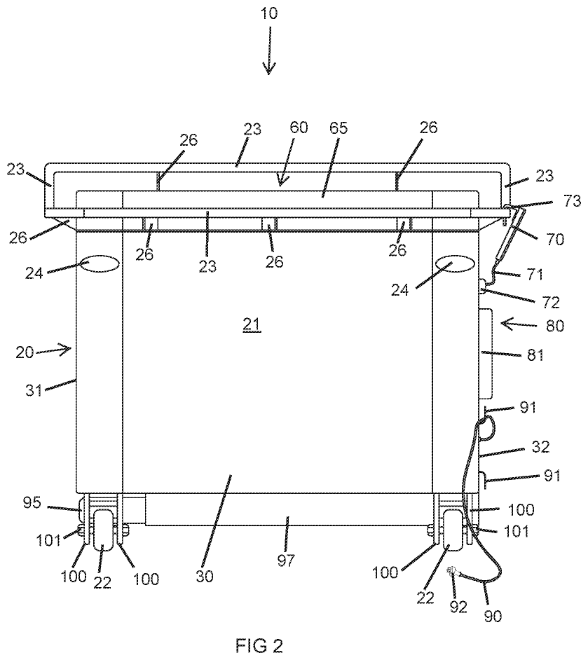

The lid 60 is shown in FIG. 1 in an open configuration and in FIGS. 2 to 7 is shown in the closed configuration. In the closed configuration, the lid 60 seals, or at least covers, the cleaning tank 20. An internal rim 64 extends around the periphery of the internal side 62 of the lid 60. When the lid 60 is in the closed positon the rim 64 is seated within a corresponding channel 25 in the top side and extending around and between the major and minor sides 30, 31, 32, 35 of the external cabinet 21 and the major and minor sides 30a, 31a, 32a, 35a of the internal tank 28. The lid 60 closes the opening in the cleaning tank 20 to effectively seal the cleaning tank 20 in the closed position. A hinge 61 attached to the top side of the rear major side 35 and to the lid 60, allows the lid 60 to rotate between the closed and open positions. The hinge 61 provides the pivotal connection and attachment of the lid 60 to the external cabinet 21 and the internal tank 28. Also shown in FIG. 1 on the internal surface 62 of the lid 60 is the drip rail 63. The drip rail 63 ensures that any moisture or condensation which is on the internal surface 62 of the lid 60 when in the open position will gather into the drip rail 63 and then be drained back into the internal tank 28 when the lid 60 is moved to the closed position. The outer surface 65 of the lid 60 forms a flat panel when the lid 60 is in the closed position and when the lid 60 is in the open position the outer surface 65 rests against the handrail 23 at the rear of the cleaning tank 20.

In the open position, the lid 60 permits access to the internal tank 28 and allows for the introduction and removal of kitchen articles from the support structure 40 within the internal tank 28 by an operator 11. The support structure or basket 40 is a generally rectangular basket 40 with four side walls 41 to fit within the internal tank 28. A vertical support arm 42 extends from the base of the basket 40 to a point above the top of the basket 40. A lid engaging arm 43 is attached to the end of the vertical support arm 42 to raise and lower the lid 60. The lifting assembly 110 is attached to the lid engaging arm 43 of the basket 40 to raise and lower the basket 40 and lid 60 simultaneously. The lifting assembly 110 is connected to raise and lower the support frame or basket 40. The vertical motion of the support structure or basket 40 raises the lid 60. That is, the frictional engagement of the bearings 44 mounted on the vertical support arm 42 in rotational engagement against the internal surface 62 of the lid 60 to raise the lid 60.

With the basket 40 supported from the lifting assembly 110 in order to avoid any sideways rotation during raising and lowering of the basket, especially when the basket is loaded with heavy kitchen articles, the basket and internal tank have guide members 47, 48. Fitted to the ends of the basket 40 and the sides 31a, 32a of the internal tank 28 are guide members 47, 48 which are configured to assist with linearly raising and lowering the support frame or basket 40 and avoiding any sideways rotation.

Also illustrated in FIGS. 1 and 2 are the lockout warning lights 24 attached at either end of the front major side 30. The warning lights 24 provide a visual indication to the operator 11 that the temperature of the cleaning fluid 29 within the cleaning tank 20 has exceeded a pre-determined temperature. If the lockout warning lights 24 are activated a qualified technician is required to reset the system prior to continuing use of the cleaning apparatus 10.

FIGS. 2 to 6 show front, rear, side and top plan views of the cleaning apparatus 10. FIG. 2 shows the front plan view with the two lockable castor wheels 22 on either end of the bottom of the cleaning tank 20. Each castor wheel assembly 22 is mounted to the underside of the base 33 with the castor fork 100 rotatably mounted to the base 33. Each fork 100 has an axle hole for receiving the wheel axle shaft 101. A stop 102 is mounted on each one of the front two castor wheel assemblies 22 to prevent rotation of the wheel 22 and therefore movement of the cleaning apparatus 10.

With the lid 60 in the closed position as illustrated in FIG. 2 the raised section of the handrail 23 is shown projecting above the top of the rear of the cleaning tank 20. This section of the handrail 23 is mounted to the rear side 35 of the external cabinet 21 by angle brackets 26. As previously described this section of handrail 23 is utilised as a mechanical stop for the lid 60 in the raised position. The remaining sections of the handrail 23 are mounted to the outside of the external cabinet 21 on each side 30, 31, and 32 by angle brackets 26.

Also mounted to the bottom or base 33 is the u or v-shaped channel 97 which internally houses the heating element 130. To one end of the u or v-shaped housing 97 is the fluid drain pipe 95 and valve 96. The valve and drain pipe 95, 96 as the name indicates allows the operator 11 to drain the cleaning fluid 29 from the cleaning tank 20 when required. FIG. 2 also shows the remote control 70 when not being used is conveniently releasably attached to the handrail 23 using mounting bracket 73. The remote control 70 and cable 71 are connected to the cleaning tank 20 through connector 72 located above or adjacent the control panel 80.

Also illustrated in FIG. 2 is the end 32 with the power lead 90 and power plug 92 for connecting the cleaning apparatus 10 to the mains power. When not in use the power lead 90 is looped around a cable retainer 91 attached to the side 32 of the external cabinet 21. FIG. 2 also illustrates the electrical control panel closure door 81 and control panel 80 which will be described in more detail below.

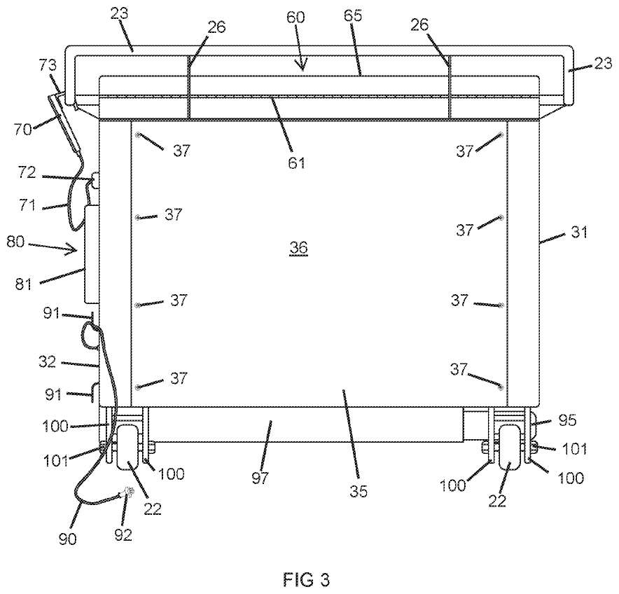

FIG. 3 shows a rear plan view of the cleaning apparatus 10. A rear panel 36 is attached by a plurality of screw retainers 37, the rear panel 36 covers the electrical system and the lifting means 110. Also shown in FIG. 3, two castor wheels 22 are mounted to the bottom of the rear side 35, each of these castor wheels 22 do not include a stopper.

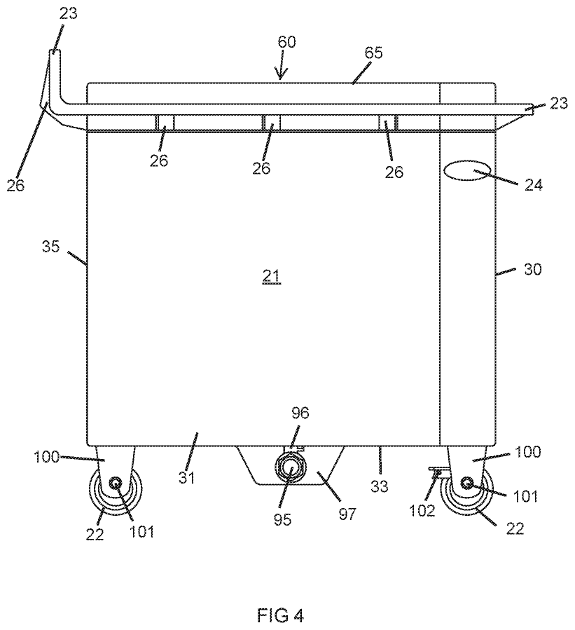

FIG. 4 shows an end view of the cleaning apparatus 10 as viewed from the end 31 of the cleaning tank 20. From this view the drain pipe and valve 95, 96 are clearly viewed extending from an end of the u or v-shaped housing 97 located on the bottom side 33 of the external cabinet 21. The valve 96 is used to ensure the fluid 29 is retained within the cleaning tank 20 when the valve 96 is in the closed position, the valve 96 when placed in the open position allows the cleaning fluid 29 to drain from the internal tank 28. Also shown more clearly here is the difference between the front castor wheel 22 and the rear castor wheel 22. The front castor wheel 22 has the stopper 102 for preventing rotation of the wheel 22.

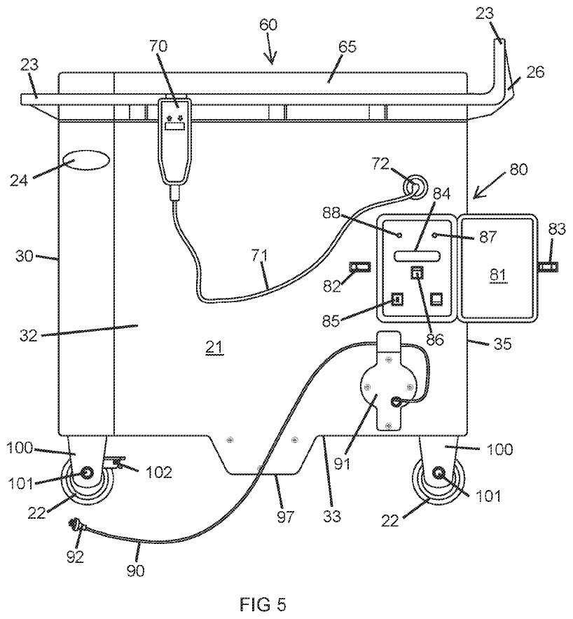

FIG. 5 shows the opposing end of the cleaning tank 20 to that described in FIG. 4 above. In FIG. 5 the electrical control panel 80 is shown with the control panel door 81 connected by hinge 89 to one side of the control panel 80. The control panel door 81 is secured to the external cabinet 21 and closes the control panel 80 by any know retaining device. As illustrated in FIG. 5 an over-center clasp 82 is fitted to the external cabinet 21 and a corresponding hook 83 is fitted to the door 81. When the door 81 is in the closed position the clasp 82 retains the hook 83 to secure the door 81 closed.

The control panel 80 shows the mains on/off switch 86, the transfer switch 85 for controlling the lifting means 110, a temperature indicator 84 for providing a visual indication of the temperature of the cleaning fluid 29 within the cleaning tank 20 and both the power on 88 and heater on lights 87. FIG. 5 like FIG. 2 also shows the remote control 70 and cable 71 connected to the cleaning tank 20 through connector 72.

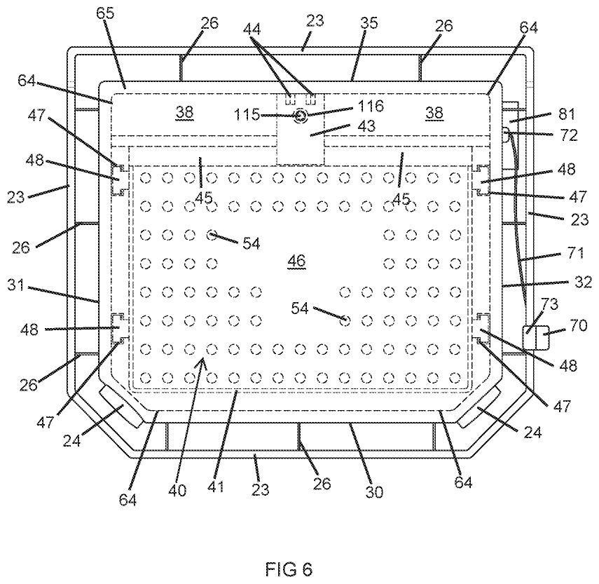

FIG. 6 shows a top view of the cleaning apparatus 10 with the lid 60 in the closed position. The components within the cleaning tank 20 are shown in hidden detail as dashed lines. The support structure or basket 40 has four sides 41 forming the rectangular structure. The basket 40 has two major sides 41 and two minor sides 41 which form the rectangular structure. A removable grate 46 sits in the bottom of the basket 40. The grate 46 has a plurality of draining apertures 54. The draining apertures 54 permit flow and circulation of cleaning fluid 29 through the basket 40, as well as assisting with removal of fluid 29 from the basket 40 when lifted from the cleaning tank 20. The support structure or basket 40 may be considered to be configured in a complementary manner with the internal tank 28, i.e., having a generally rectangular configuration. The rear side wall 41 of the basket 40 is reinforced by panel 45. The panel 45 allows the vertical support arm 42 to pass through the panel 45 to the base 53 of the support structure or basket 40. The top edge 52 of the walls 41 of the basket 40 are rolled to provide a safety edge to allow the operator 11 to easily insert and remove kitchen articles from the support structure 40.

Also described above, the guide members 47, 48 are fitted to the ends of the basket 40 and the sides 31a, 32a of the internal tank 28 to assist with linearly raising and lowering the support frame or basket 40. Pairs of lifting guides or rails 47 are fitted to the walls 31a, 32a of the internal tank 28. The rails 47 extend vertically down each wall 31a, 32a from a position adjacent the top of each wall 31a, 32a for substantially the length of the walls 31a, 32a from top to bottom. The rails 47 are a substantially c-shaped channel for receiving the complementary shaped guide elements 48 which are mounted to the outside of the opposing end walls 41 of the support frame 40. The guide elements 48 are designed to run in the rails 47 as the support frame 40 moves up and down within the cleaning tank 20. The guide elements 48 are a t-shaped element which effectively evenly space the support frame 40 away from the channels 47 to ensure that the support frame 40 moves easily within the channels 47 without binding or becoming wedged within the internal tank 28 under load.

The lid engaging arm 43 is also illustrated in FIG. 6. The lid engaging arm 43 is fixed to the top of the vertical support arm 42 and attached to the telescoping arm 116 of the lifting means 110 by a fastener 115. The lid engaging arm 43 extends substantially perpendicular from the top of the vertical support arm 42 and in a direction towards the rear of the cleaning tank 20. Rotatably mounted to one end of the lid engaging arm 43 are bearings or rollers 44. As the lifting means 110 extends the bearings 44 rotate against the inner surface 62 of the lid 60 to move the lid 60 from a closed position to an open position on the cleaning apparatus 10. The frictional engagement of the rollers or bearings 44 against the inner surface 62 of the lid 60 raises the lid 60 from the closed position where the lid 60 seals the top of the cleaning tank 20 to an open position where the operator 11 can easily access the inside of the cleaning tank 20.

FIG. 6 also illustrates the handrail 23 evenly spaced away from the external cabinet 21 around the periphery of the cleaning tank 20. The brackets 26 mount the handrail 23 adjacent to the top edge of each side 30, 31, 32, 35 of the cleaning apparatus 10.

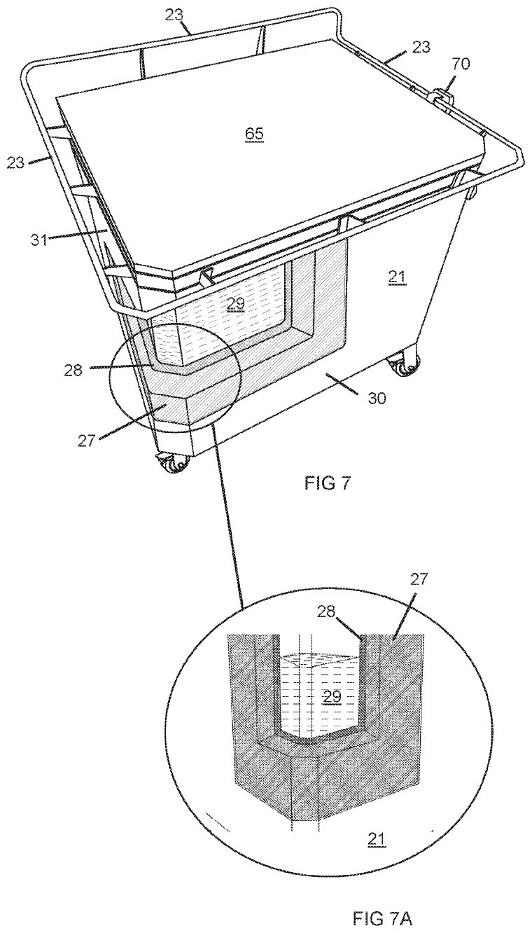

FIGS. 7 and 7A illustrate the insulating material 27 located between the external cabinet 21 and the internal tank 28. As described above the insulating material 27 is typically a polyurethane spray foam or the like, which is used to fill the space between the internal tank 28 and the external cabinet 21. The internal tank 28 holds the cleaning fluid 29 within and as the heating system heats the fluid 29 the insulating material 27 forms a barrier to both conductive and convective heat transfer.

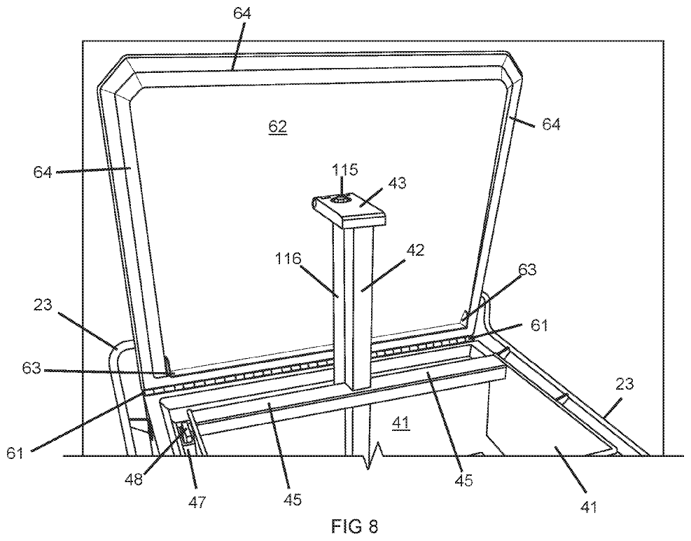

FIG. 8 shows a section of the top of the cleaning apparatus 10 with the lid 60 in the open position. In this position the telescopic arm 116 of the lifting means is extended so that the support frame 40 is positioned adjacent the opening in the cleaning tank 20 to allow an operator 11 access to within the support frame 40. In this position the tops of the guide elements 48 of the support structure 40 are just visible above the channels 47 mounted to the side walls 31a, 32a of the internal tank 28. As is illustrated with the telescopic arm 116 extended the lid engaging arm 43 moves up along the internal surface 62 of the lid 60 with the bearings 44 engaging the internal surface 62. The lid 60 rotates about the hinge 61 to the open position. Also illustrated well here is the rim 64 around the periphery of the lid 60 which when the lid 60 is in the closed position is engaged against the corresponding edge or recessed channel 25 located around the periphery of the top of the cleaning tank 20 to seal the lid 60 to the top of the tank 20. The rim or taper 64 which projects around the periphery of the lid 60 also reduces the crush area for the operators hand and fingers. Also well illustrated is the drip drain 63 which ensures any moisture from the internal surface 62 of the lid 60 drains back into the internal tank 28 when the lid 60 is closed.

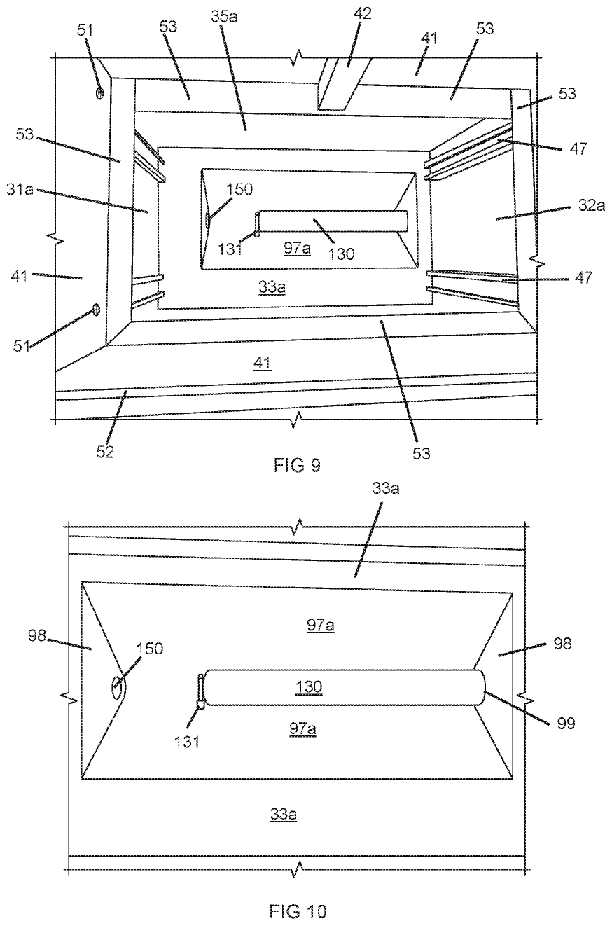

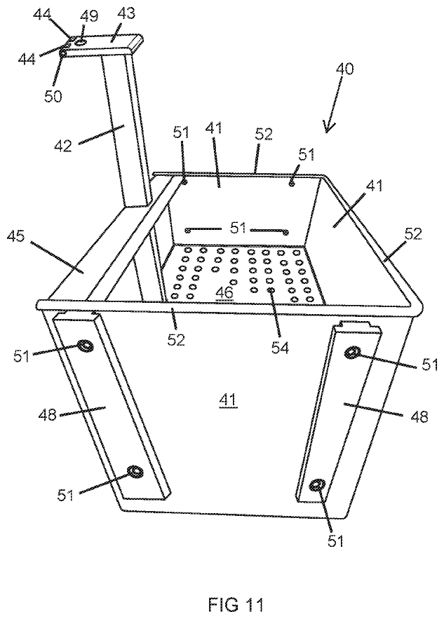

FIGS. 9 and 10 show views of inside the cleaning tank 20. FIG. 9 shows the support frame 40 with the grate 46 removed to provide more clarity to the underlying structure. In this position the support frame 40 is in the same position as that illustrated in FIG. 8. With the grate 46 removed we can see the heating element 130 located within the housing 97a in the bottom of the internal tank 28. The heating element 130 is supported at one end by mounting point 131 and at an opposing end passes through an aperture 99 in one of the end walls 98 of the housing 97a. Also within the housing 97a and located at one end 98 is the drain opening 150 which is in fluid communication with the drain pipe 95. The internal walls 30a, 31a, 32a and 35a of the internal tank 28 surround the base 33a of the cleaning tank 20. The housing 97a extends downwardly from the base 33a. The channels 47 for the guiding means are also shown extending upwardly from the base 33a and along the walls 31a, 32a. Also shown running around the bottom edge of the support structure 40 is the rim or base 53 which the grate 46 is supported upon within the support structure 40.

FIG. 11 shows the support structure or basket 40 removed from the cleaning apparatus 10. The guide elements 48 are shown secured by fasteners 51 to opposing ends 41 of the support structure 40. The guide elements 48 are a t-shaped structure which fits into the channels 47 within the internal tank 28. The t-shaped guides 48 are typically a plastics material such as nylon or polyethylene or other heat resistant material. Three of the sides 41 of the support structure 40 have a rolled top edge 52. The remaining side 41 has the reinforcing plate 45 for supporting the vertical support arm 42. The reinforcing plate 45 assists in distributing the load of the kitchen articles in the support structure 40 when the support structure is being moved up and down within the cleaning tank 20. Like the other components of the cleaning tank 20 the basket 40 is also constructed from food-grade stainless steel.

FIG. 11 also shows the shaft 50 which rotatably mounts the bearings 44 within the lid engaging arm 43. The bearing 44 are mounted for rotation around the shaft 50. As noted above the bearings 44 rotate against the internal surface 62 of the lid 60 to open the lid 60 when the lifting means 110 extends to raise the support structure 40. Also illustrated is the aperture 49 into which the fastener 115 is located, the fastener 115 is used for retaining the end of the telescopic arm 116 in the lid engaging arm 43. The grate 46 with the apertures 54 is located within the support structure 40 and seated upon the rim or base 53.

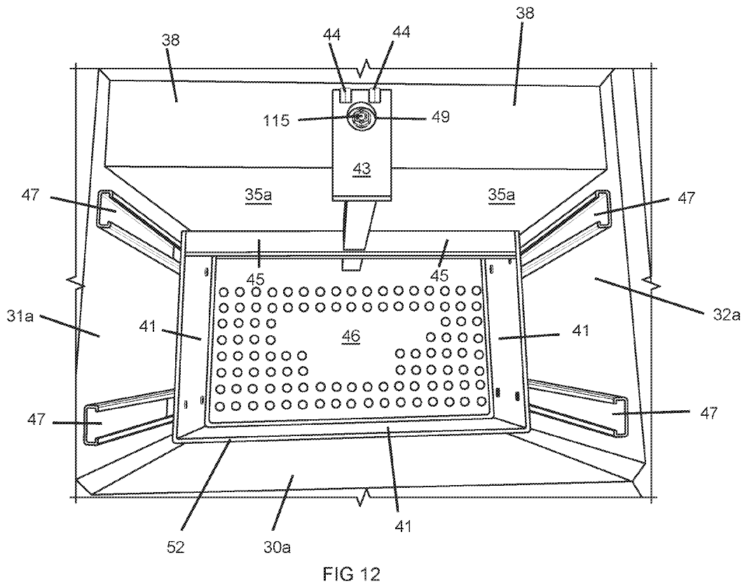

FIG. 12 shows the support structure 40 located within the internal tank 28 as it would be positioned during the immersion of the kitchen articles. The lid 60 has been removed to show the underlying structures. In this position, with the lid 60 in the closed position, the lid engaging arm 43 sits just below the inner surface 62 of the lid 60 and is located within the top wall portion 38 of the rear wall 35a of the internal tank 28. This ensures that the lid 60 will close properly to form a seal between the rim 64 on the inner side of the lid 60 when it is seated within the corresponding channel 25 in the top side and extending around opening in the cleaning tank 20. The support structure 40 sits towards the bottom of the cleaning tank 20 to allow the kitchen articles to be cleaned by the cleaning fluid 29 within the internal tank 28. The rear wall 35a of the internal tank 28 has a top wall portion 38 through which the telescoping arm 116 of the lifting means 110 extends through an aperture therein to allow the connection of the telescoping arm 116 to the lid engaging arm 43 and the vertical support arm 42. This keeps the lifting means 110 out of the internal tank 28 and therefore avoiding any contact with the cleaning fluid 29. As will be shown below the actuator 111 of the lifting means 110 is also positioned away from the internal tank 28.

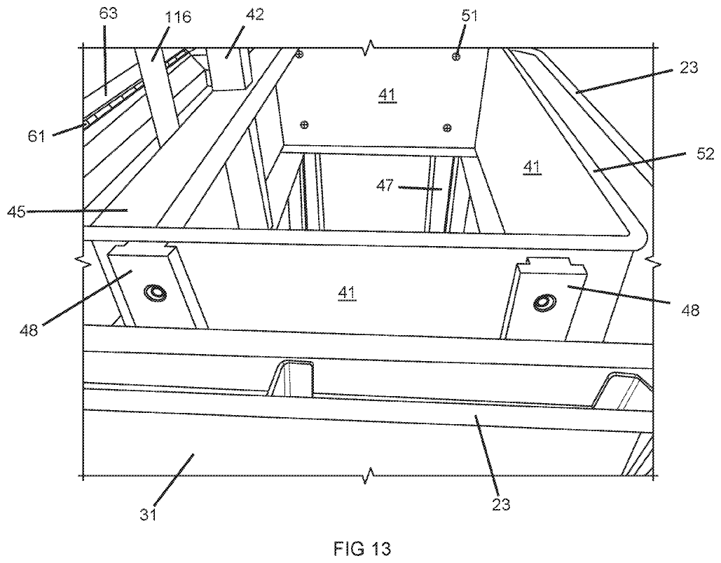

FIG. 13 shows a close up end view of the support structure 40 in the raised position with the support structure located adjacent the opening of the cleaning tank 20.

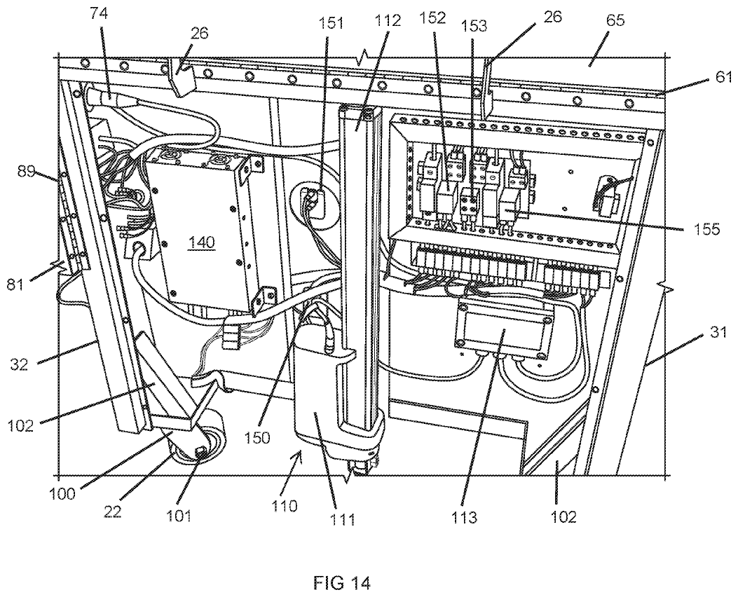

FIGS. 14 and 21 show a detailed view of the electrical components and a simplified circuit schematic of the cleaning apparatus 10. The mains power 90, 92 is connected to the mains switch 86 located within the control panel 80. When the main switch 86 is turned to on, this energizes the main contactor 152 which in turn provides power to, the power on light 88, the temperature display 84 and the heating relay 153. The heater relay 153 energizes the heating element 130 and illuminates the heater on light 87 located within the control panel 80. Mains power is also provided to the power supply 140 which reduces the input AC voltage from 240V to 24 VAC to power the ballast which converts the 24 VAC to 24 VDC for powering the electric actuator assemblies 111, 112, 113. The ballast also provides DC voltage to the overheat relay 155 for providing power to the lockout indicating lights 24 if a lockout condition exists. The temperature within the internal tank 28 is monitored by two thermostats 150, 151. The first is set to open heater relay 153 if the temperature within the tank 28 reaches 72° C. and isolate power to the heater element 130. A second thermostat 151 is used as a redundant back-up should the first thermostat 150 fail. If the first thermostat 150 fails the second thermostat 151 will open heater relay 153 if the temperature within the tank 28 reaches 85° C. and isolate power to the heater element 130. If this occurs it will also activate the overheat relay 155 and bring on the lockout indicator lights 24 located on the front side 30 of the external cabinet 21. If this condition occurs a technician is required to reset the system before it can be re-used. An operator 11 is still able to operate the actuator assemblies 110 in order to raise and lower the basket 40 and the lid 60 to gain access inside to remove any kitchen articles in the cleaning tank 20. The operator cannot however restart the heating system until the technician has reset the system.

FIG. 14 also shows the connection of the remote control 70 to the electrical cabinet via connector 74. Also well shown here is the connection of the castor wheel assemblies 22 to the underside 33 of the external cabinet 21. Each castor assembly 22 is mounted to the underside of the base 33 and supported by struts 102 positioned between the base 33 and the respective side walls 31, 32. The castor fork 100 is rotatably mounted to the base 33.

With this embodiment there is one lifting means 110. The lifting means 110 consists of the linear actuator assembly 111 with the actuator motor connected by gears to the screw shaft 112 and the telescoping arm 116. As described above the telescoping arm 116 is retained within the lid engaging arm 43 by the fastener 115. The actuator motor can be electrically driven as shown in FIG. 14 or could be hydraulically driven. The linear actuator assembly 111 converts rotary motion into linear movement to move the telescoping arm 116 and raise and lower the support structure 40 within the cleaning tank 20. The linear actuating assembly 111 is activated by the controller 113 when a signal is provided from either the remote control 70 or the transfer switch 85 located within the control panel 80.

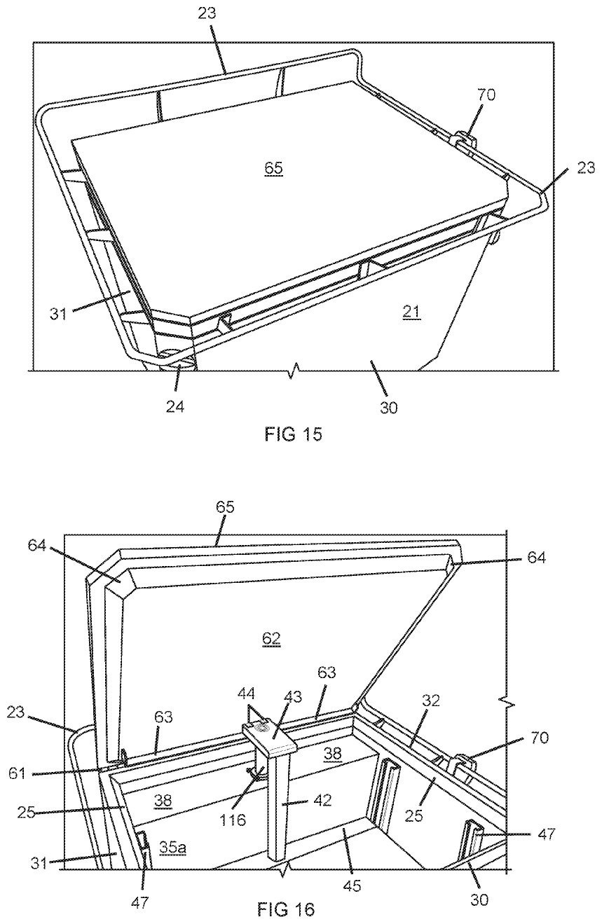

FIGS. 15 to 17 illustrate the cleaning apparatus 10 with the lid 60 and support structure or basket 40 in three different positions. FIG. 15 shows the lid 60 in the closed position with the lid 60 sealing the top of the cleaning tank 20. In use, this position would indicate the support frame 40 in the lowered position within the internal tank 28 and the kitchen articles immersed within the cleaning fluid 29. When not in use, this position would represent the stored position with the lid 60 closing the apparatus 10 and able to be stored under a kitchen work bench. FIG. 16 illustrates the cleaning apparatus 10 in a partially open position. With the operator 11 positioned a safe distance from the cleaning tank 20, the remote control 70 is used to raise the support frame 40 which simultaneously raises the lid 60. As shown the lifting means 110 is operated to extend the telescoping arm 116 which has an end retained within the lid engaging arm 43 of the support structure 40. The telescoping arm 116 extends through an aperture in the rear wall 38 of the cleaning tank 28. As the telescoping arm 116 extends it raises the lid engaging arm 43 and the vertical support arm 42. The vertical support arm 42 being attached to the support frame 40 to raise the support frame 40 and the kitchen articles from within the cleaning fluid 29. The vertical support arm 42 extends upwardly from a position centrally located on the base 53 and adjacent one of the major side walls 41 of the support frame 40. As the vertical support arm 42 raises the support frame 40 and at the same time the lid engaging arm 43 and the rollers 44 contact the underside 62 of the lid 60 to start raising the lid 60. The lid 60 is pivotally connected by hinge 61 to the major side 35 of the cleaning tank 20. The lid 60 is not connected to the support frame 40 other than through the frictional engagement and the rotational connection of the bearings 44 on the internal surface 62 of the lid 60.

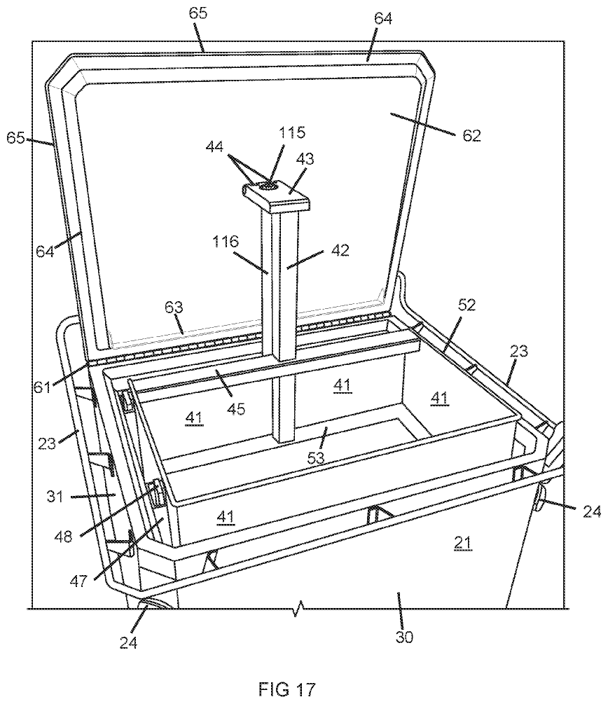

FIG. 17 shows the lid 60 and the support frame 40 in the fully raised position in which the support frame 40 is positioned at the opening of the cleaning tank 20 and the operator 11 can easily remove the cleaned kitchen articles from the support frame 40. In this position the lid 60 is in the open position in which the top surface 65 of the lid 60 rests against the handrail 23 at the rear of the cleaning apparatus 10. Also in this position the rollers 44 are still in contact with the underside 62 of the lid 60. As the telescoping arm 116 retracts with the lid engaging arm 43 the support frame 40 descends back into the cleaning tank 20. At the same time the lid 60 under its own weight returns to the closed position as shown in FIG. 15, the lid 60 seals the opening of the cleaning tank 20. The lid 60 under the forces of gravity will descend to the closed position as the telescoping arm 116 retracts the lid engaging arm 43 and the support frame 40.

Once the support frame 40 has been reloaded with kitchen articles to be cleaned an operator 11 can once again step back a safe distance from the cleaning apparatus 10 and using the remote control 70, lower the telescoping arm 116 of the lifting means 110 and return the support frame 40 to the cleaning fluid 29 within the internal tank 28.

FIG. 18 shows a further embodiment of a cleaning apparatus 200 in accordance with the present invention. The first embodiment covers smaller sized cleaning apparatus 10 in the range of up to 160 L. This second embodiment is designed to cover the larger capacity cleaning apparatus 200 and typically above 200 L in size. The present invention provides a cleaning apparatus 10, 200 in sizes ranging from 160 L up to 1100 L. In this embodiment there are two lifting means 110 which means all of the lifting mechanism is duplicated including the vertical support arms 42, lid engaging means 43, telescoping arms 116 and all associated components. However, all of the components perform the same task as previously described for the cleaning apparatus 10. The only major difference being that to ensure that the lifting means 110 extend at the same rate and time the two lifting means 110 are synchronized for operation. This ensures that both telescoping arms 116 extend at the same time and rate. This also means that the support frame 40 will raise and lower evenly and not bind within the internal tank 28.

FIG. 18 shows a cleaning apparatus 200 with a cleaning tank 20. The cleaning tank 20 is formed by the external cabinet 21, an internal tank 28 separated by an insulating material 27. The internal cabinet 28 is designed to retain a cleaning fluid 29 within the internal tank 28. The insulating material 27 which fills the space between the internal tank 28 and the external cabinet 21 is the same as the insulating material 27 used in the first embodiment and prevents energy loss and provides a more energy efficient soak tank 200.

The cleaning tank 20 of the cleaning apparatus 200 may be considered to have a generally rectangular configuration the same as the first embodiment. In other words, the external cabinet 21 as shown in FIG. 18 can be considered to have two opposing longer or major, sides 30, 35 and two opposing shorter or minor, sides 31, 32. The internal tank 28 also has a generally rectangular shape with two opposing longer or major, sides 30a, 35a and two opposing shorter or minor, sides 31a, 32a. The external cabinet 21 also has a base or bottom 33 with a u or v-shaped channel 97 extending substantially along the length of the base 33 and positioned either side of the centerline running through the cleaning tank 20. The internal tank 28 has a corresponding base 33a with the u or v-shaped channel 97a, the channel 97a is shaped to house the heating element 130. The cleaning tank 20 is designed to have a particular depth or height to allow immersion of the kitchen articles.

Like the first embodiment, located on each corner of the base 33 are castor wheels 22. At least two, and preferably the two castor wheels 22 located adjacent the front major side 30 of the soak tank 200 are able to be locked to prevent movement of the soak tank 200. A handrail 23 extends around the periphery of the top of the cleaning tank 20. The part of the handrail 23 which extends along the rear side 35 is inclined upwards at either end to raise the height of the handrail 23 to a position in which the handrail 23 act as a stop for the lid 60 when the lid 60 is in the open position.

The lid 60 is shown in FIG. 18 in an open configuration. In the closed configuration, the lid 60 seals, or at least covers, the cleaning tank 20. An internal rim 64 extends around the periphery of the internal side 62 of the lid 60. When the lid 60 is in the closed positon the rim 64 is seated within a corresponding channel 25 in the top side and extending around and between the major and minor sides 30, 31, 32, 35 of the external cabinet 21 and the major and minor sides 30a, 31a, 32a, 35a of the internal tank 28. The lid 60 closes the opening in the cleaning tank 20 to effectively seal the cleaning tank 20 in the closed position. A hinge 61 attached to the top side of the rear major side 35 and to the lid 60, allows the lid 60 to rotate between the closed and open positions. The hinge 61 provides the pivotal connection and attachment of the lid 60 to the external cabinet 21 and the internal tank 28. Also shown in FIG. 18 on the internal surface 62 of the lid 60 is the drip rail 63. The outer surface 65 of the lid 60 forms a flat panel when the lid 60 is in the closed position and when the lid 60 is in the open position the outer surface 65 rests against the handrail 23.

In the open position, the lid 60 permits access to the internal tank 28 and allows for the introduction and removal of kitchen articles from the support structure 40 within the internal tank 28 by an operator 11. The support structure or basket 40 is a generally rectangular basket 40 with four side walls 41 to fit within the internal tank 28. Two vertical support arms 42 extend from the base 53 of the basket 40 to a point above the top of the basket 40. The two vertical support arms 42 are spaced apart an equal distance either side of the centerline running through the middle of the cleaning tank 20. A lid engaging arm 43 is attached to each vertical support arm 42 to raise and lower the lid 60. A lifting assembly 110 is attached to each lid engaging arm 43 of the basket 40 to raise and lower the basket 40 and lid 60 simultaneously. The lifting assemblies 110 are connected to raise and lower the support frame or basket 40. The vertical motion of the support structure or basket 40 raises the lid 60. That is, the frictional engagement of the bearings 44 mounted on the vertical support arms 42 in rotational engagement against the internal surface 62 of the lid 60 to raise the lid 60.

With the basket 40 supported from the lifting assemblies 110 in order to avoid any sideways rotation during raising and lowering of the basket, especially when the basket is loaded with heavy kitchen articles, guide members 47, 48 are required. Fitted to the ends of the basket 40 and the sides 31a, 32a of the internal tank 28 are guide members 47, 48 which are configured to assist with linearly raising and lowering the support frame or basket 40.

Also illustrated in FIG. 18 is the lockout warning lights 24 attached at either end of the front major side 30. In use, the operator 11 from a safe distance, using the remote control 70 can raise and lower the support frame 40 which simultaneously raises and lowers the lid 60.

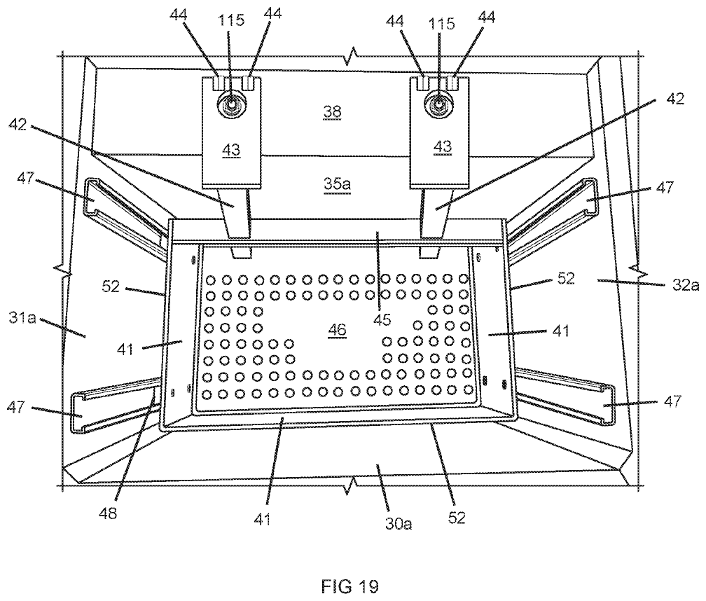

FIG. 19 shows the support structure 40 located within the internal tank 28 as it would be positioned during the immersion of the kitchen articles in the cleaning apparatus 200. The lid 60 has been removed to show the underlying structures. In this position, with the lid 60 in the closed position, the lid engaging arms 43 sit just below the inner surface 62 of the lid 60 and are located within the top wall portion 38 of the rear wall 35a of the internal tank 28. This ensures that the lid 60 will close properly to form a seal between the rim 64 on the inner side of the lid 60 when it is seated within the corresponding channel 25 in the top side and extending around opening in the cleaning tank 20. The support structure 40 sits towards the bottom of the cleaning tank 20 to allow the kitchen articles to be cleaned by the cleaning fluid 29 within the internal tank 28. The rear wall 35a of the internal tank 28 has a top wall portion 38 through which the two telescoping arms 116 of the lifting means 110 extends through apertures therein to allow the connection of the telescoping arms 116 to the lid engaging arms 43 and the vertical support arms 42. This keeps each lifting means 110 out of the internal tank 28 and therefore avoiding any contact with the cleaning fluid 29. As will be shown below each actuator 111 of each lifting means 110 is also positioned away from the internal tank 28.

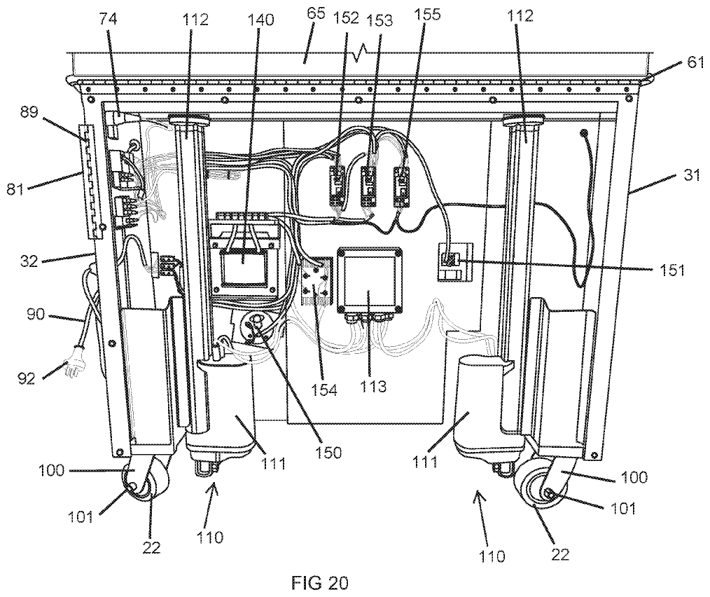

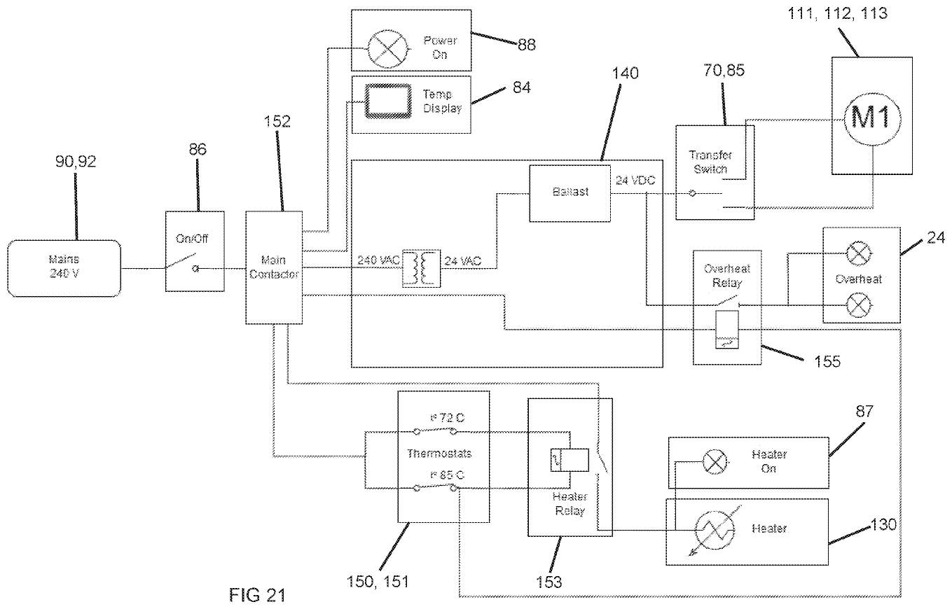

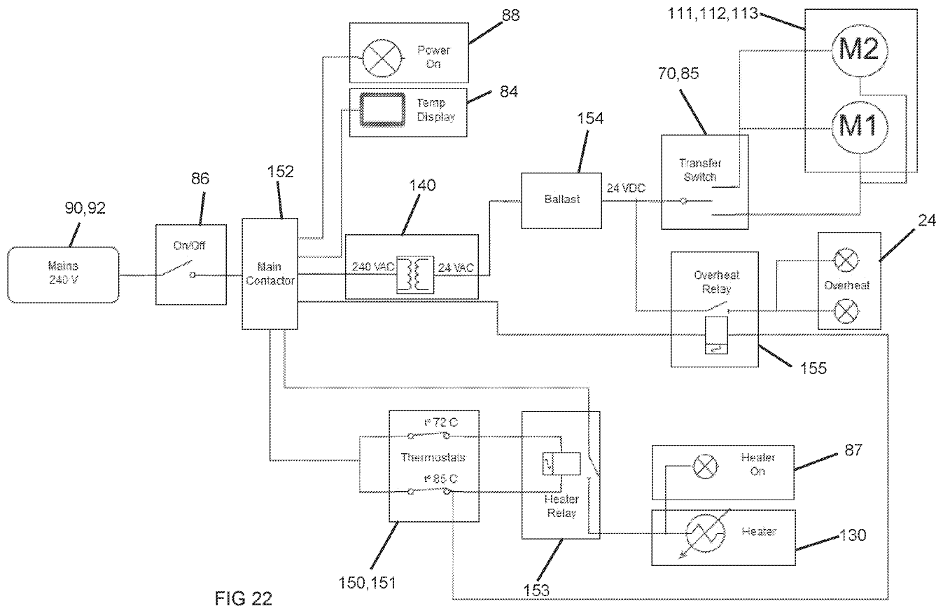

FIGS. 20 and 22 show a detailed view of the electrical components and a simplified circuit schematic of the cleaning apparatus 200. While the majority of the components are the same as the first embodiment there are some distinct differences. The mains power 90, 92 is connected to the mains switch 86 located within the control panel 80. When the main switch 86 is turned to on, this energizes the main contactor 152 which in turn provides power to, the power on light 88, the temperature display 84 and the heating relay 153. The heater relay 153 energizes the heating element 130 and illuminates the heater on light 87 located within the control panel 80. Mains power is also provided to the transformer 140 which reduces the input AC voltage from 240V to 24 VAC to power the ballast 154 which converts the 24 VAC to 24 VDC for powering both electric actuator assemblies 111, 112, 113. The ballast 154 also provides DC voltage to the overheat relay 155 for providing power to the lockout indicating lights 24 if a lockout condition exists. The temperature within the internal tank 28 is monitored by two thermostats 150, 151. The first is set to open heater relay 153 if the temperature within the tank 28 reaches 72° C. and isolate power to the heater element 130. A second thermostat 151 is used as a redundant back-up should the first thermostat 150 fail. If the first thermostat 150 fails the second thermostat 151 will open heater relay 153 if the temperature within the tank 28 reaches 85° C. and isolate power to the heater element 130. If this occurs it will also activate the overheat relay 155 and bring on the lockout indicator lights 24 located on the front side 30 of the external cabinet 21. If this condition occurs a technician is required to reset the system before it can be re-used. An operator 11 is still able to operate the actuator assemblies 110 in order to raise and lower the basket 40 and the lid 60 to gain access inside to remove any kitchen articles in the cleaning tank 20. The operator cannot however restart the heating system until the technician has reset the system.

FIG. 20 also shows the connection of the remote control 70 to the electrical cabinet via connector 74. Also well shown here is the connection of the castor wheel assemblies 22 to the underside 33 of the external cabinet 21. The castor fork 100 is rotatably mounted to the base 33.

With this embodiment there are two lifting means 110. Each lifting means 110 consists of the linear actuator assembly 111 with the actuator motor connected by gears to the screw shaft 112 and the telescoping arm 116. As described above each telescoping arm 116 is retained within the lid engaging arm 43 by the fastener 115. The actuator motors can be electrically driven as shown in FIG. 14 or could be hydraulically driven. The linear actuator assemblies 111 convert rotary motion into linear movement to move the telescoping arms 116 and raise and lower the support structure 40 within the cleaning tank 20. The linear actuating assemblies 111 are activated and synchronized by the controller 113 when a signal is provided from either the remote control 70 or the transfer switch 85 located within the control panel 80.

Most of the components of the present invention are constructed from food grade stainless steel. This is mainly due to the environment in which the cleaning apparatus 10, 200 are used, for example in sanitary food handling applications. While predominantly being used in commercial or industrial kitchens the cleaning apparatus 10, 200 is required to be easily maintained and cleaned.

### Advantages

A number of advantages are apparent in the present invention. The present invention provides a cleaning apparatus with an automated lifting mechanism which can be remotely operated to raise and lower the support frame or basket within the cleaning tank and also simultaneously raise and lower the lid. The support frame is designed to carry kitchen articles which require cleaning. The support frame moves from a position adjacent the opening of the cleaning tank where the operator can easily load the support frame with the kitchen articles to a lowered position where the kitchen articles are immersed within a cleaning fluid. A heating element within the cleaning tank will heat the cleaning fluid and the kitchen articles remain immersed in the heated cleaning fluid for a pre-determined period of time. The operator can then using the remote control from a safe distance away from the cleaning tank raise the support frame which will also raise the lid.

The present invention provides a cleaning tank which is safe and easy to operate. There is little chance that an operator will be scalded by any heated moisture which will typically escape as the lid is opening. The operator uses the remote control from a safe distance away from the opening of the cleaning tank. The automated lifting means also reduces the chance that an operator will injure themselves from manually raising and lowering the sometimes very heavy basket from within the cleaning tank. The automated lifting means raises the basket to a position adjacent the opening to allow the operator to easily remove and/or load the basket. The lifting means will then lower the basket back in to the tank and the lid will automatically close to allow the cleaning of more kitchen articles.

The automated lifting mechanism also provides the soak tank of the present invention with the highest safety standards. The design of the lid which seals within the opening of the cleaning tank removes the need for dangerous latch mechanisms or any gas assisted struts to open and close the lid.

The insulation which sits within the space between the external cabinet and the internal tank also ensures that the operator will not come into contact with any heated external cabinet. The insulation forms a barrier to both conductive and convective heat transfer. The insulation material also provides some form of structural integrity to walls of the cleaning apparatus while keeping the external cabinet always cool to touch. By providing an insulating material which provides a high thermal resistance aids in reducing the operating costs of the cleaning apparatus. The insulating material prevents energy loss and provides a more energy efficient soak tank.

### VARIATIONS

It will be realized that the foregoing has been given by way of illustrative example only and that all other modifications and variations as would be apparent to persons skilled in the art are deemed to fall within the broad scope and ambit of the invention as herein set forth.

As used herein the term “and/or” means “and” or “or”, or both.

As used herein “(s)” following a noun means the plural and/or singular forms of the noun.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the scope of the above described invention.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

1. A cleaning apparatus comprising:
a cleaning tank adapted to contain a fluid for immersing kitchen articles, the cleaning tank having a generally rectangular configuration with an opening, the cleaning tank having an external cabinet spaced apart from an internal tank with an upper edge formed therebetween, the external cabinet and internal tank having two opposing major sides, two opposing minor sides and a recessed channel formed in the upper edge and extending around the major and minor sides of the external cabinet and internal tank;
a lid pivotally connected to one of the major sides of the cleaning tank, the lid adapted to allow access to the cleaning tank when opened and to close the opening of the cleaning tank in use, the lid having a raised rim which when the lid is in the closed position is received within the recessed channel in the upper edge between the external cabinet and the internal tank to seal the opening of the cleaning tank;
a horizontally disposed support frame for supporting the kitchen articles within the cleaning tank, the support frame has a generally rectangular configuration with a pair of major side walls, a pair of minor side walls and a base;
a vertical support member extends upwardly from a position centrally located on the base and adjacent one of the major side walls of the support frame;
a heating system disposed within the cleaning tank and adapted to heat the fluid therein;
a lift assembly located between the external cabinet and a rear wall of the internal tank, the lift assembly is adapted to raise and lowering the support frame;
a remotely operated control system with a remote control for operating the lift assembly, the remote control allowing an operator located a sate distance from the cleaning apparatus to raise and lower the support frame; and
wherein as the support frame is raised and lowered, the vertical support member engages with an internal surface of the lid, such that when the lifting means moves the support frame from the lowered position to the raised position the vertical support member raises the lid.

2. (canceled)

3. A cleaning apparatus as claimed in claim 1, wherein the space between the external cabinet and the internal tank contains an insulating material designed to restrict the propagation of heat from the internal tank to the external cabinet.

4. A cleaning apparatus as claimed in claim 1, wherein the lift assembly comprises a lifting means connected to the support frame to move the support frame from a lowered position in which the kitchen articles are immersed in the fluid and the lid is in the closed position, and a raised position wherein the support frame is in close proximity to the opening of the cleaning tank such that it is easily accessed and the lid is in the open position.

5. A cleaning apparatus as claimed in claim 1, wherein the apparatus further comprises one or more lifting guides being provided within the internal tank and/or support frame, and configured to assist with linearly raising and lowering of the support frame.

6. A cleaning apparatus as claimed in claim 5, wherein the lifting guides comprise one or more rails or channels together with complementary guide elements.

7. A cleaning apparatus as claimed in claim 6, wherein a pair of rails or channels are provided on each opposing minor side wall of the internal tank, each rail or channel extending vertically down from a position adjacent the opening of the cleaning tank, and the guide elements are a T-shaped element provided on the support frame.

8. (canceled)

9. A cleaning apparatus as claimed in claim 7, wherein the support frame is shaped to fit within the internal tank.

10. A cleaning apparatus as claimed in claim 9, wherein the T-shaped guide elements are provided on an external side of one or more of the minor side walls of the support frame, each T-shaped guide element is positioned to correspond with one of the pair of rails or channels on the opposing minor side walls of the internal tank to allow the support frame to be guided for movement within the internal tank.

11. A cleaning apparatus as claimed in claim 9, wherein the support frame base has a bottom portion which comprises a plurality of draining apertures.

12. A cleaning apparatus as claimed in claim 1, wherein the support frame further comprises a lid engaging member extending perpendicular to and depending from an end of the vertical support member, the lid engaging member comprises at least one rolling element adapted to engage the internal surface of the lid, such that when the lifting means moves the support frame from the lowered position to the raised position the rolling element engages with the internal surface of the lid to simultaneously raise the lid.

13. A cleaning apparatus as claimed in claim 1, wherein the support frame further comprises two vertical support members spaced apart an equal distance either side of a centerline running through the middle of the cleaning tank and extending from the base and adjacent one of the major side walls of the support frame and a lid engaging member extending perpendicular to and depending from an end of each vertical support member, the lid engaging member comprises at least one rolling element adapted to engage the internal surface of the lid, such that when the lifting means moves the support frame from the lowered position to the raised position the rolling element engages with the internal surface of the lid to simultaneously raise the lid.

14. (canceled)

15. A cleaning apparatus as claimed in claim 13, wherein the lifting means further comprises an actuating assembly connected to the each lid engaging member, the actuating assemblies connected to each vertical support member are synchronised such that they travel the same distance at the same time.

16. (canceled)

17. A cleaning apparatus as claimed in claim 15, wherein the actuating assemblies comprises an electric linear actuator and a telescopic element whereupon action of the electric linear actuator causes the telescopic element to extend or retract according to the movement of the actuator, the electric linear actuator and the telescopic element are positioned to be located between the external cabinet and the rear wall of the internal tank, and the telescopic element extends through an aperture located in a top section of the rear wall of the internal tank.

18-22. (canceled)

23. A cleaning apparatus as claimed in claim 1, wherein the lid is pivotally connected by a hinge to one of the major sides of the cleaning tank, the lid further comprises a drip rail attached adjacent a side of the inner surface of the lid, when the lid is the open position, the drip rail is adapted to provide a channel back into the internal tank of the cleaning apparatus for fluid accumulated on the inner surface of the lid during use.

24. (canceled)

25. A cleaning apparatus as claimed in claim 1, wherein the heating system comprises a heating element, at least one thermostat to control the temperature of the heated fluid, a temperature sensor and an indicator to show the temperature of the fluid in the cleaning apparatus.

26. A cleaning apparatus as claimed in claim 1, wherein the heating system comprises two thermostats, a first thermostat to prevent the heating fluid from exceeding a pre-determined temperature and a second thermostat as a redundant backup should the first thermostat fail.

27. A cleaning apparatus as claimed in claim 26, wherein the heating system further comprises a lockout system which is activated by the second thermostat to indicate that the temperature of the fluid within the internal tank has exceeded the pre-determined temperature and the first thermostat has failed to operate.

28. A cleaning apparatus as claimed in claim 27, wherein the lockout system further comprises at least one indicator located on the external cabinet to provide a visual warning that the second thermostat has been activated, and the lockout system is adapted to shut-down operation of the cleaning apparatus and requires a technician to reset the cleaning apparatus prior to re-use.

29-37. (canceled)

38. A cleaning apparatus as claimed in claim 12, wherein the lifting means further comprises an actuating assembly connected to the lid engaging member.

39. A cleaning apparatus as claimed in claim 38, wherein the actuating assembly comprises an electric linear actuator and a telescopic element whereupon action of the electric linear actuator causes the telescopic element to extend or retract according to the movement of the actuator, the electric linear actuator and the telescopic element are positioned to be located between the external cabinet and the rear wall of the internal tank, and the telescopic element extends through an aperture located in a top section of the rear wall of the internal tank.
